(19) United States
(12) Patent Application Publication
(10) Pub. No.: US 2022/0207787 A1
(43) Pub. Date: Jun. 30, 2022

(54) METHOD AND SYSTEM FOR INSERTING SECONDARY MULTIMEDIA INFORMATION RELATIVE TO PRIMARY MULTIMEDIA INFORMATION

(71) Applicant: Q Alpha, Inc., Apex, NC (US)

(72) Inventor: Milan Blair Reichbach, Apex, NC (US)

(73) Assignee: Q Alpha, Inc., Apex, NC (US)

(21) Appl. No.: 17/561,123

(22) Filed: Dec. 23, 2021

Related U.S. Application Data
(60) Provisional application No. 63/131,144, filed on Dec. 28, 2020.

(51) Int. Cl. G06T 11/00; G06Q 30/02

(52) U.S. Cl. CPC G06T 11/00; G06Q 30/0276

(57) ABSTRACT

A method and system for displaying multimedia information, implemented in an electronic device, includes receiving data at the electronic device. The data includes a first dynamic multimedia information and a secondary multimedia information. The electronic device displays, on a display, the first dynamic multimedia information. Based upon a criteria, the secondary multimedia information is displayed within the first dynamic multimedia information.

### CROSS REFERENCE TO RELATED APPLICATION

This application claims the benefit of U.S. Provisional Patent Application Ser. No. 63/131,144, filed on Dec. 28, 2020, the contents of which are incorporated herein by reference as if fully set forth.

### FIELD OF INVENTION

This application relates to the field of advertising and promotion, and in particular, is related to overlaying or inserting secondary multimedia information into or onto primary multimedia information.

### BACKGROUND OF THE INVENTION

Various forms of multimedia information are constantly being viewed, streamed, or otherwise consumed by users or viewers. Providing information, such as advertisements or other promotional messages, that capture a viewer's attention. has become more difficult as viewers have become more accustomed to ads, and have adjusted. to the timing of advertisements, such as during predetermined. breaks or intermissions in multimedia information, such as television commercials. Additionally, websites or other streaming sites that, insert information for viewing are typically cumbersome or include buttons to close or otherwise fast forward through the information.

in other forms of multimedia information, such as the internet, video games, virtual reality, augmented reality, neural-based multimedia information, and other forms of emerging technology, it is often difficult to provide information to users in an intuitive way.

Accordingly, there is a growing need to provide improved methods, processes, and systems that allow for insertion of signage, advertisements, or other forms of indicia into multimedia information.

### SUMMARY OF THE INVENTION

The systems and methods disclosed herein are directed to a method including inserting secondary multimedia information into primary multimedia information, wherein at least the primary multimedia information is dynamic.

In one aspect, the secondary multimedia information is overlaid at a preselected location of the primary multimedia information.

The secondary multimedia information may be dynamic.

The secondary multimedia information is configured to be inserted into the primary multimedia information at a random temporal moment or at a moment scheduled in such a way to surprise the viewer, for example.

The secondary multimedia information can be inserted in a particular location or on a particular object that does not otherwise include any type of secondary multimedia information, or does not typically include any type of secondary multimedia information. In another aspect, the secondary multimedia information can be overlaid in a location or on an object that typically does include some sort of information or signage, such as a billboard, a blank television or computer screen, a newspaper, or other object in the background of the primary multimedia information. However, the above are some examples, and the secondary multimedia information can be overlaid in additional areas or locations.

A service provider may insert the secondary multimedia information into the primary multimedia information, and a customer may pay the service provider for inserting the secondary multimedia information into the primary multimedia information.

Payment for inserting the secondary multimedia information into the primary multimedia information can be based on, for example, at least one of: duration of the secondary multimedia information, size of the secondary multimedia information, or visibility of the secondary multimedia information.

The secondary multimedia information may be in the form of an advertisement.

The secondary multimedia information is overlaid onto a dynamic aspect within the primary multimedia information. That is, the secondary multimedia information may be overlaid onto an aspect of the primary multimedia information that changes.

The primary multimedia information may include at least one of: video, image, hologram, augmented reality, virtual reality, graphic interchange format image, audio, odor, neural file, haptic signal, or any other signal, file, or mechanism configured to attract a user's attention.

The secondary multimedia information may be the same type of media as the primary multimedia information, or may otherwise be any other type of attention drawing or attracting element, signal, or mechanism.

The method may also include delivering the primary multimedia information including the overlaid secondary multimedia information to a third party.

In one aspect, a method may include automatically identifying a target area in primary multimedia information, and overlaying secondary multimedia information on the target area in the primary multimedia information such that the secondary multimedia information is integrated within the primary multimedia information.

In one aspect, a method is disclosed that includes receiving secondary multimedia information from a first user or client, and overlaying the secondary multimedia information onto primary multimedia information. In one aspect, the primary multimedia information is from a third party that is different than the first user or client. The third party may receive payment for allowing the overlaying of the secondary multimedia information in the primary multimedia information.

In another aspect, a method includes receiving an advertisement from a first user or client, identifying primary multimedia information suitable for being overlaid with the advertisement, and overlaying or inserting the advertisement at a random time and location within the primary multimedia information.

In one aspect, the advertisement is configured to wrap around or lay flat on an object within the primary multimedia information such that the advertisement appears to be integral with the primary multimedia information.

The advertisement can be configured to stay fixed on an object that is moving within the primary multimedia information. The advertisement can be dynamic and change based on time or location. The advertisement and the primary multimedia information are related at least with respect to one aspect. The advertisement does not exist initially within the primary multimedia information, and only becomes apparent after a predetermined action relative to the primary multimedia information, in one aspect.

Additional embodiments, variations and aspects are disclosed herein.

### BRIEF DESCRIPTION OF THE DRAWINGS

The foregoing Summary and the following Detailed Description will be better understood when read in conjunction with the appended drawings, which illustrate a preferred embodiment of the invention. In the drawings:

FIG. 1 illustrates one aspect of providing secondary multimedia information within primary multimedia information.

FIG. 2 illustrates one aspect of a flowchart showing processes associated with providing secondary multimedia information within primary multimedia information.

FIG. 3 illustrates an aspect of a display screen showing a video game, where secondary media can be overlaid or otherwise inserted into the video game images.

FIG. 4 illustrates an aspect of a display screen of a video image, such as a movie or television program, where secondary media can be overlaid or otherwise inserted into the image.

FIG. 5 illustrates another aspect in which secondary media is overlaid onto a body part in a moving image.

FIG. 6 is a schematic diagram of an example system for displaying multimedia information.

FIG. 7 is a schematic block diagram of an example wireless device operating in the example system of FIG. 6.

FIG. 8 is a schematic block diagram of an example server operating in the example system of FIG. 6.

### DETAILED DESCRIPTION OF PREFERRED EMBODIMENTS

The present systems, apparatus, and methods are generally configured to insert secondary multimedia information into primary (or first) multimedia information.

As used herein, the term primary multimedia information can refer to any type of image, motion picture, television program, video file or image, streaming content, virtual reality, augmented reality, neural-based content, hologram, or other type of sensory experience configured to be experienced by a user. The term multimedia information as used herein also includes any type of hypermedia.

As used herein, the term secondary multimedia information can refer to any form of signage, information, indicia, or advertisements in one aspect. In other aspects, the term secondary multimedia information can refer to any type of multimedia information, including video, images, etc. In one aspect, the secondary multimedia information is essentially an image, moving picture, sound, video, GIF, or other aspect that is overlaid or inserted relative to primary multimedia information. The secondary multimedia information can include multimedia information that is either static or dynamic. In other words, the secondary multimedia information can be dynamic and change over time (i.e. time evolutionary), can change in response to the primary or underlying multimedia information, etc.

In one aspect, the primary and secondary multimedia information are time evolutionary in that both are configured to modify over time with respect to at least one aspect.

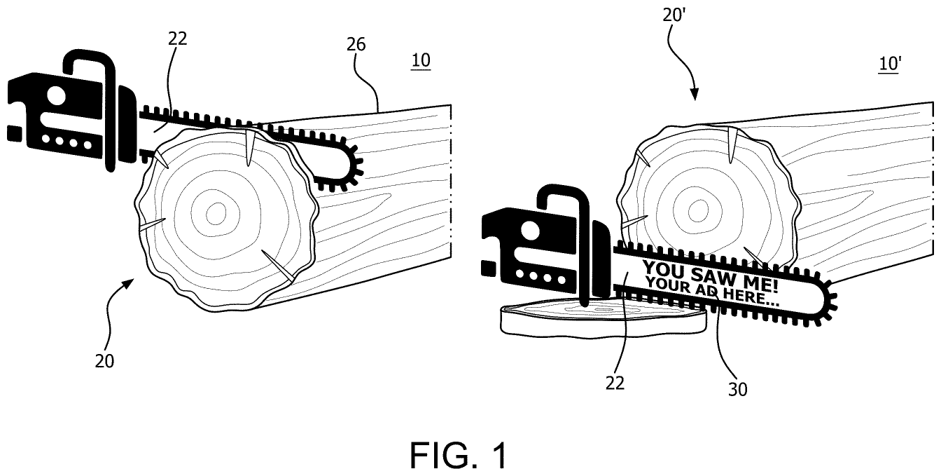

In one aspect, the secondary multimedia information is inserted and tracks or is positioned relative to a specific aspect, area, or location within the primary multimedia information. FIG. 1 illustrates one such example of this arrangement. FIG. 1 illustrates two snapshots 10, 10′ of primary multimedia information 20, 20′. As shown in FIG. 1, secondary multimedia information 30 is inserted into an underlying multimedia information motion image 20, 20′. The secondary multimedia information 30, which is illustrated as an ad for saw, is dynamically positioned on the blade 22 of the saw 24. As the saw 24 cuts through the log 26 in the multimedia information 20, 20′, the secondary multimedia information 30 stays fixed on the blade 22 of the saw 24 and moves dynamically within the primary multimedia information 20′. As illustrated in FIG. 1, the secondary multimedia information 30 is not present in snapshot 10, and only appears in the second snapshot 10′ of the multimedia information 20′ after the saw 24 has sufficiently cut a portion of the log to reveal the face of the blade 22. This configuration provides an element of surprise with respect to placing the secondary multimedia information 30 in an unexpected location with respect to the multimedia information 20′. Accordingly, the secondary multimedia information 30 is more likely to be seen by viewers of the multimedia information. As used herein, the terms surprise and random are used interchangeably, and both are directed to the concept that the secondary multimedia information is introduced relative to the primary multimedia information at times when a viewer would not ordinarily expect to see secondary multimedia information or in locations that the viewer would not ordinarily expect to secondary multimedia information, in addition to an example where the secondary multimedia information is introduced randomly. The secondary multimedia information may be introduced at some time later than a starting point in time of the primary multimedia information.

In the embodiments in which the secondary multimedia information 30 is an advertisement, increased visibility corresponds to increased sales of whatever is being advertised via the secondary multimedia information 30. The processes disclosed herein embed, overlay, or otherwise insert the secondary multimedia information 30 in such a manner that the secondary multimedia information 30 is only revealed upon a specific action taking place in the multimedia information 20, 20′, in one aspect.

FIG. 1 illustrates one aspect of the present disclosure relative to a motion picture or video file. However, one of ordinary skill in the art would understand that this configuration is adaptable to any type of multimedia information and any type of indicia. For example, the secondary multimedia information may be inserted on a rotating object within primary multimedia information. In another aspect, the secondary multimedia information may be inserted on a background aspect of the primary multimedia information, such as a billboard in a television or movie scene.

In one aspect, a method is provided in which a provider receives secondary multimedia information from a client. As used herein, the term provider is used to refer to an entity that could be an advertising provider, or other type of service provider. The provider can be a vendor which specializes in placing advertisements for clients such that the advertisements have visibility for users or customers.

The term client refers to any entity that generally desires to place secondary multimedia information (e.g., advertisements) such that customers will see the secondary multimedia information.

The term user broadly refers to members of the general public in one aspect. The user does not necessarily have to provide payment for viewing the multimedia information. In one aspect, the user is also a potential customer of the client.

The provider serves as an intermediary between the client, who wishes to engage users, and the users. In one aspect, the client pays the provider in to insert the client's secondary multimedia information relative to primary multimedia information. Parameters regarding placement of the secondary multimedia information can vary depending on the length of time displaying the secondary multimedia information, prominence of the secondary multimedia information (e.g. size, shape, etc.), secondary elements (such as audio plus visual indicia), among other variables. The provider can either generate the secondary multimedia information or the client can provide secondary multimedia information that has already been generated.

The provider inserts, overlays, or otherwise adds the secondary multimedia information to a primary multimedia information source. In one example, the primary multimedia information source can be a webpage, television show, movie, video game, video file, GIF file, virtual reality file, augmented reality file, neural-based file, or other type of multimedia information.

The secondary multimedia information can be inserted by the provider in a random or unexpected manner. In other words, the secondary multimedia information can be inserted in a particular location or on a particular object that does not otherwise include any type of secondary multimedia information, or does not typically include any type of secondary multimedia information. In another aspect, the secondary multimedia information can be overlaid in a location or on an object that typically does include some sort of information or signage, such as a billboard, a blank television or computer screen, a newspaper, or other object in the background of the primary multimedia information.

In one aspect, personnel with the provider manually inserts the secondary multimedia information using placement and tracking tools or software such that the secondary multimedia information moves naturally and seamlessly within the primary multimedia information. For example, a service provider can manually select predetermined locations and moments for inserting the secondary multimedia information relative to the primary multimedia information, in one aspect. In other aspects, an algorithm or other automated process can scan the primary multimedia information and automatically detect areas of high visibility or otherwise desirable locations and moments for placing secondary multimedia information within the primary multimedia information. For example, the algorithm may be configured to scan the primary multimedia information for suitable potential target areas for placing the secondary multimedia information based on the dimensions of a potential target areas (i.e. whether the potential target area is flat and large enough to display secondary multimedia information), or based on other characteristics, such as the duration, visibility, prominence, etc. of the potential target area for the secondary multimedia information. Each of these parameters may be automatically set or can be manually set.

In one aspect, the client provides both the primary multimedia information and the secondary multimedia information. The provider then strategically inserts the secondary multimedia information relative to the primary multimedia information, such that the secondary multimedia information will have maximum visibility and impact on potential customers or users. The client can then receive the combined primary multimedia information and secondary multimedia information file or data, and the client can distribute it among customers or users. Alternatively, the provider can serve as a conduit between the client and a third party, such as a content provider, cable company, website host, or other entity, and the provider can send the combined primary multimedia information and secondary multimedia information file or data to third parties for distribution.

In a general aspect, the present disclosure is directed to tools for specifically simplifying the creation of inserted surprise elements (e.g. advertisements) in various multimedia information formats.

In another aspect, the present disclosure is directed to the ability to have an advertisement vary after each time the advertisement is run or displayed by overlaying the advertisement dynamically with streaming multimedia information.

In one aspect, this disclosure provides the ability to display multimedia information on players that allow user interaction with the secondary multimedia information. In one aspect, the interaction can include a user clicking on the secondary multimedia information. In another aspect, a customized player interface is provided that is configured to allow users to interact with secondary multimedia information. User interaction may include a gaming aspect in which a user clicks or otherwise interacts with the secondary multimedia information, and the user then earns some type of reward or prize. In one aspect, the reward or prize can include discounts for services or goods, credits, tokens, or other form of payment. The player interface may include a timer configured to begin counting down after the secondary multimedia information is introduced. A size or quantity of the reward or prize may be linked to the time remaining on the timer when a user interacts with the system or secondary multimedia information.

In another aspect of this disclosure, insertion of the secondary multimedia information may be dynamic and based on aspects or characteristics of the user. For example, in one aspect, a user's gaze or other cues such as pupillometry or other metrics can be obtained from the user by the system. This data from the user can then be used to affect the timing, positioning, and other characteristics of the secondary multimedia information. For example, a user's pulse can be detected by the system using a sensor that is configured to detect subtle changes in the user's skin or any other pulse-sensing device. In one aspect, sensors or cameras are incorporated with facial action coding systems which are configured to detect specific facial muscle movements to determine a user's response to the multimedia information. One skilled in the art would understand that any one or more of these components can be integrated to any one or more of the embodiments disclosed herein in order to provide more dynamic interaction with a user.

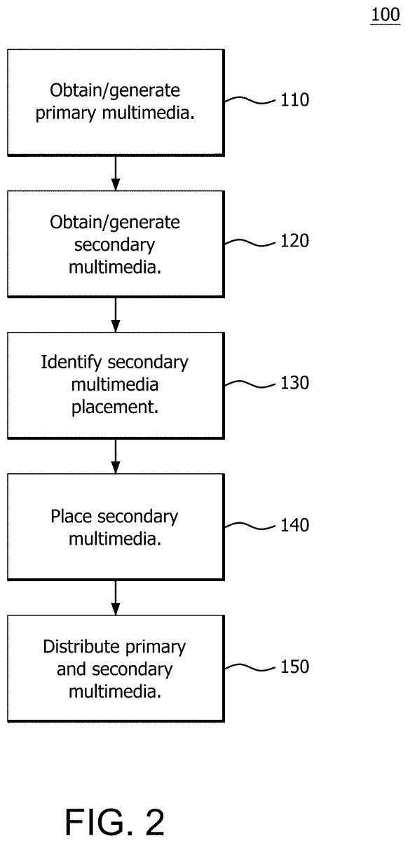

FIG. 2 illustrates a flow diagram showing the steps associated with one method or process 100. As shown in FIG. 2, step 110 includes obtaining or generating primary multimedia information. Step 110 can include obtaining primary multimedia information from a third party or directly from a client. The primary multimedia information can include any of the formats described herein.

Step 120 includes generating or obtaining secondary multimedia information. Step 120 can also include obtaining the secondary multimedia information from a third party or directly from a client. The secondary multimedia information can include any of the formats described herein.

Step 130 includes identifying or otherwise locating a specific time, place, and manner for inserting, overlaying, or otherwise placing the secondary multimedia information in the primary multimedia information. Step 130 can be automated, manually performed, or otherwise carried out. Step 130 can be performed by the provider or client, or by a third party.

Step 140 includes inserting, overlaying, or otherwise placing the secondary multimedia information within the primary multimedia information in the predetermined location and at a predetermined time.

Step 150 then includes distributing the combined primary multimedia information and secondary multimedia information file, data, etc. This step can include sending the combined file to a content provider, cable company, website host, or other entity. Step 150 can also include sending the combined file back to a client or directly to customers, viewers, or users.

One skilled in the art would understand that any one or more of these steps may be omitted, or additional steps or processes may be implemented within the process 100.

In one embodiment, the primary and/or secondary multimedia information can include images or data that is provided via a generative adversarial network. In other words, machine learning aspects can be integrated to provide the primary and/or secondary multimedia information.

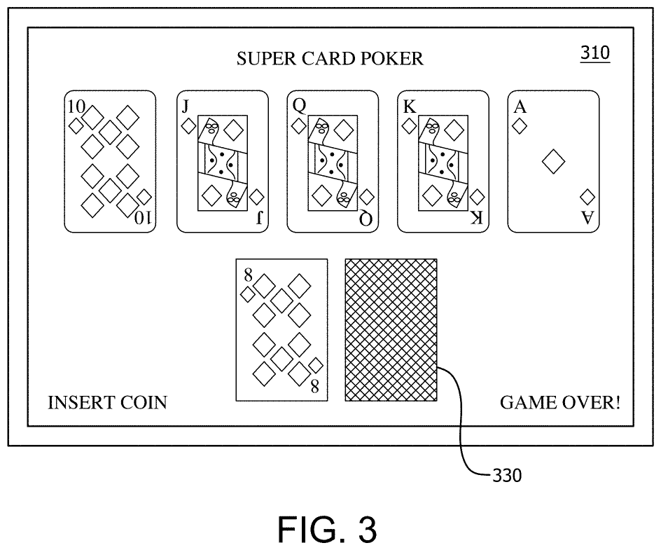

As shown in FIG. 3, an aspect of a display screen showing a video game is illustrated. As shown in FIG. 3, secondary media 330 can be overlaid or otherwise inserted into video game images 310. In this arrangement, the underlying video game image 310 (i.e. the primary multimedia information) includes a series of playing cards. The secondary media 330 is randomly inserted and overlaid onto one of the playing cards at a random time for example.

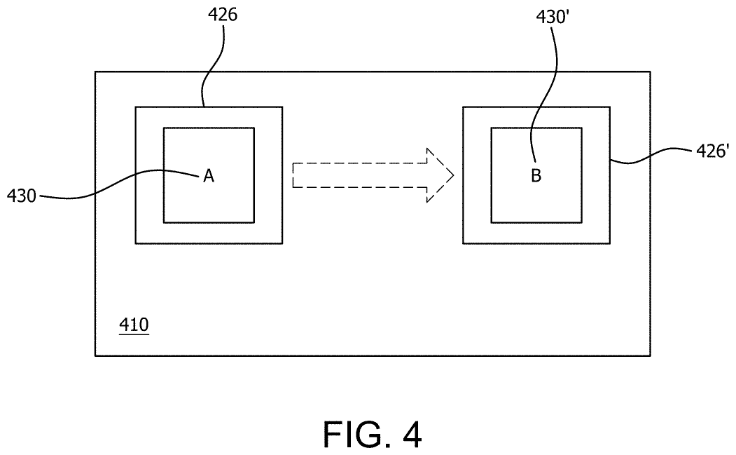

FIG. 4 illustrates an aspect of a display screen of a video image, such as a movie or television program, where secondary media 430, 430′ can be overlaid or otherwise inserted into the image 410. As shown in FIG. 4, object 426, 426′ is moving through the frame of the image 410. As the object 426, 426′ moves, secondary media 430, 430′ changes based on the object's movement. The object 426, 426′ is shown generically in FIG. 4, however one skilled in the art would understand that this concept can be adapted such that secondary media is inserted onto any object in a video image, such as a television screen, tablet, watch face, or other monitor or display surface in the video image. In one aspect, the secondary media is inserted onto a holographic, three-dimensional, or augmented reality image or system. One skilled in the art would understand that the secondary media can be inserted onto any object in a video image.

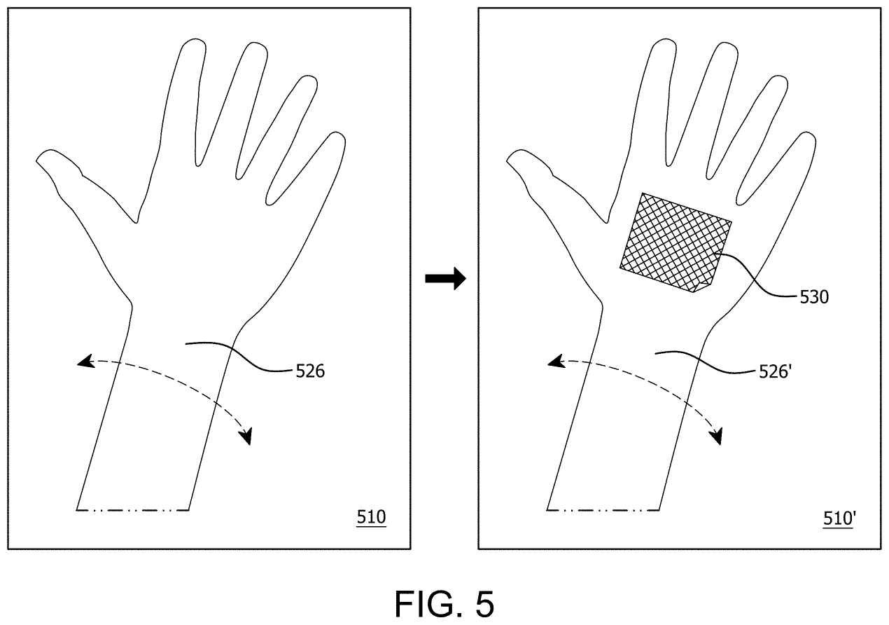

FIG. 5 illustrates another aspect in which secondary media is overlaid onto a body part in a moving image 510, 510′. As show in FIG. 5, a hand 526, 526′ is waving back and forth. As the hand 526, 526′ waves, secondary media 530 is randomly inserted onto the body part in a specific location. As shown in FIG. 5, the secondary media 530 is inserted onto a palm of the hand 526′. One skilled in the art would understand that the secondary media 530 could be inserted into any location of the body part.

A method for displaying multimedia information, implemented in an electronic device is disclosed herein, in one aspect. As used in this context, the term electronic device can include devices such as a cellular phone, tablet, laptop computer, televisions, monitor, desktop computer or any other device capable of receiving data electronically by either wireless or wired means.

The method can include receiving data at the electronic device, and the data can include at least one of a first dynamic multimedia information and a secondary multimedia information. The method can include displaying, by the electronic device, on a display the first dynamic multimedia information. The method can also include displaying, based upon a criteria, the secondary multimedia information within the first dynamic multimedia information. As used in this context, the term criteria can include criteria such as described above. For example, the criteria may include placing the secondary multimedia information on a particular object that does not otherwise include any type of secondary multimedia information, or does not typically include any type of secondary multimedia information. In another aspect, the criteria for displaying secondary multimedia information can include the secondary multimedia being overlaid in a location or on an object that typically does include some sort of information or signage, such as a billboard, a blank television or computer screen, a newspaper, or other object in the background of the primary multimedia information.

One of ordinary skill in the art would understand based on this disclosure that the criteria could also include other aspects or features. The criteria can be based on a random temporal moment or a moment scheduled in such a way to surprise a viewer of the secondary multimedia information based upon a second predefined criteria. For example, the second predefined criteria can include the expiration of a selected a random time after an initial starting time or initiation of the first dynamic multimedia information. For example, in a video, the random temporal moment can be after the initial frame. The assigning or scheduling of the temporal moment can also be achieved via manual intervention or can be done automatically.

The secondary multimedia information can be overlaid at a preselected location of the first dynamic multimedia information. This preselection can be determined based on manual intervention, in one aspect. The preselection can also be determined based on an algorithm or other automated process that scans the first dynamic multimedia information and automatically detect areas of high visibility or otherwise desirable locations and moments for placing the secondary multimedia information therein. The secondary multimedia information can be overlaid onto a dynamic aspect within the first multimedia information.

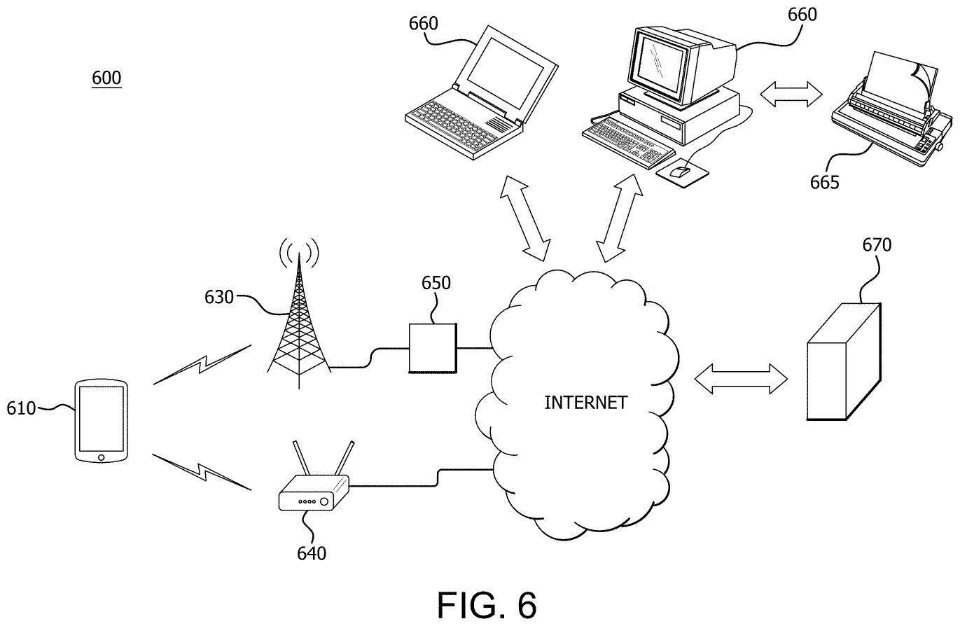

FIG. 6 is a schematic diagram of an example system 600 for displaying multimedia information. The system 600 includes a wireless device 610. The wireless device 610 may be in wireless communication with a cellular base station 630 and/or a wireless router 640 for connection to the Internet to transmit and receive data. The wireless device 610 may also include a display for displaying images, such as multimedia information to a user or viewer.

The base station 630 may be connected to the Internet via a Core Network 650, (e.g., Radio Network Controller, Gateway, or the like), or any other connection scheme. Similarly, the wireless router 640 may be connected to the Internet via any connection. The system also includes one or more computing devices 660 (e.g. clients) and a provider server 670, all of which are also connected to the Internet by any type of connection. A printer 665 may be in communication with the one or more computing devices 660 in order to receive printouts.

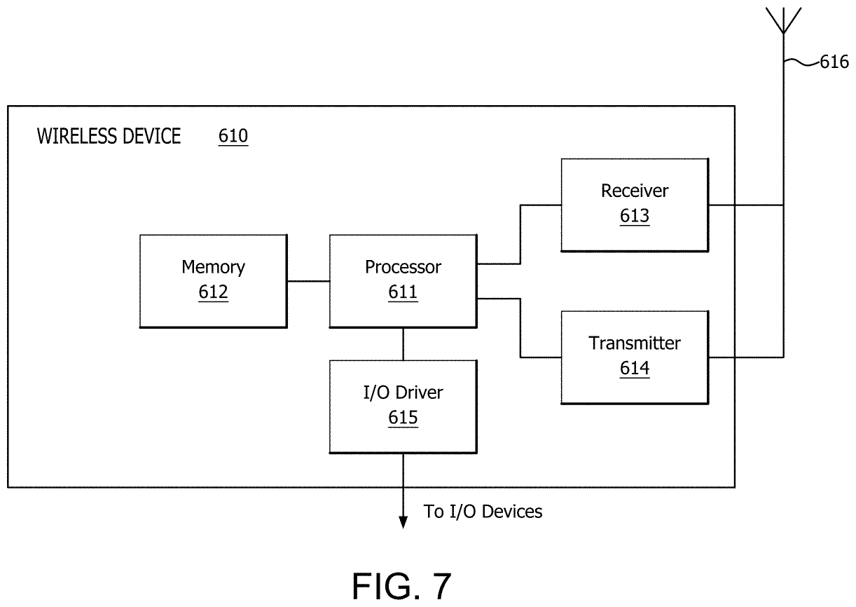

FIG. 7 is a schematic block diagram of an example wireless device 610 operating in the example system 600 of FIG. 6. The wireless device 610 includes a processor 611, a memory 612 in communication with the processor 611, a receiver 613 in communication with the processor 611, a transmitter 614 in communication with the processor 611, an Input/Output Device Driver (I/O driver) 615 in communication with the processor 611, and an antenna 616 in communication with the receiver 613 and the transmitter 614. The processor 611 is configured to receive data from the I/O driver 615, as well as to receive and send data to the memory 612. The processor 611 is further configured to control receive data from the receiver 613 via the antenna 616, and to control the transmitter 614 to transmit data wireless via antenna 616. The I/O driver 615 is configured to be connected to, for example, one or more of a USB port, audio jack connection, Bluetooth connection, or other connection.

The processor 611 is further configured to receive inputs from, for example a client or provider (not shown). The inputs received from the client or provider may include the primary multimedia information or the secondary multimedia information described above as well as information to process and display the primary multimedia information and the secondary multimedia information in accordance with, for example, the method 100 described above in FIG. 2. In addition, the processor 611 may control a display of the wireless device 610 to display visual content, such as multimedia information to a user or viewer.

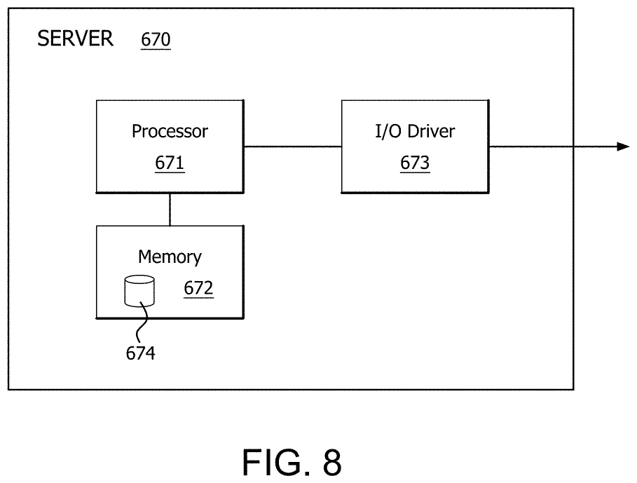

FIG. 8 is a schematic block diagram of an example server 670 operating in the example system 600 of FIG. 6. The sever 670 includes a processor 671, a memory 672 in communication with the processor 671, and an I/O driver 673 in communication with the processor. The memory 662 includes, for example, a database 674 for storing and extracting data. The I/O driver 673 transmits data to and receives data from the processor 671 for external transmission, (e.g., from and to the Internet). The server 670 may be utilized by a provider to provide information, such as the primary multimedia information and the secondary multimedia information describe above, to a user of the device 610 shown in FIG. 6.

In an embodiment, the primary multimedia information and the secondary multimedia information may be provided to the user of wireless device 610 by the computing devices 160 or the server 170. The display on the screen of the device 610 then displays the primary multimedia information and the secondary multimedia information to the user as described above. Additionally, it should be understood that although the wireless device 610 is depicted as being wirelessly connected to the Internet via the base station 630 and/or the router 640, the wireless device could be wired to the Internet instead of being connected wirelessly, (e.g., wired to router 640).

Further, the wireless device 610 may be similar to the computing devices 660, (e.g., a laptop or desktop computer).

Any one or more of the processes, elements, steps, or components disclosed herein can be implemented via a central processing unit (CPU), a network of CPUs, graphics processing unit (GPU), or other electrical devices.

The methods, systems, processes, and other embodiments disclosed herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, solid state drive (SSD), and/or other types of computer-readable storage units, and digital versatile disks (DVDs).

Having thus described the present embodiments in detail, it is to be appreciated and will be apparent to those skilled in the art that many physical changes, only a few of which are exemplified in the detailed description of the embodiments, could be made without altering the inventive concepts and principles embodied therein. For example, the methods and systems described herein may be utilized in a metaverse environment.

It is also to be appreciated that numerous embodiments incorporating only part of the preferred embodiment are possible which do not alter, with respect to those parts, the inventive concepts and principles embodied therein.

The present embodiments and optional configurations are therefore to be considered in all respects as exemplary and/or illustrative and not restrictive, the scope of the embodiments being indicated by the appended claims rather than by the foregoing description, and all alternate embodiments and changes to this embodiment which come within the meaning and range of equivalency of said claims are therefore to be embraced therein.

What is claimed is:

1. A method for displaying multimedia information, implemented in an electronic device, the method comprising:
receiving data at the electronic device, the data including a first dynamic multimedia information and a secondary multimedia information;
displaying, by the electronic device, on a display, the first dynamic multimedia information; and
displaying, based upon a criteria, the secondary multimedia information within the first dynamic multimedia information.

2. The method according to claim 1 wherein the secondary multimedia information is overlaid at a preselected location of the first dynamic multimedia information.

3. The method according to claim 1 wherein the secondary multimedia information is dynamic.

4. The method according to claim 1 wherein the criteria for displaying the secondary multimedia information within the first dynamic multimedia information includes any combination of the following: a random temporal moment or a moment scheduled in such a way to surprise a viewer of the secondary multimedia information based upon a second predefined criteria.

5. The method according to claim 1 wherein the electronic device receives the first multimedia information and the secondary multimedia information from a service provider.

6. The method according to claim 1 wherein the secondary multimedia information is an advertisement.

7. The method according to claim 1 wherein the secondary multimedia information is overlaid onto a dynamic aspect within the first multimedia information.

8. The method according to claim 1 wherein the secondary multimedia information is overlaid onto the first multimedia information at a preselected location of the first multimedia information.

9. The method according to claim 1 wherein the first multimedia information includes at least one of: video, image, hologram, augmented reality, virtual reality, graphic interchange format image, audio, odor, neural file, or haptic signal.

10. The method according to claim 1 wherein a target area is identified by the electronic device in the first multimedia information for display of the secondary multimedia information.

11. A system for displaying multimedia information, comprising:
a first device; and
an electronic device comprising a processor operatively coupled with and communication with a display, the processor configured to:
receive data from the first device, the data including a first dynamic multimedia information and a secondary multimedia information;
display the first dynamic multimedia information on the display; and
display, based upon a criteria, the secondary multimedia information within the first dynamic multimedia information.

12. The system according to claim 11 wherein the first device is a provider server or a client device in communication with the electronic device.

13. The system of claim 11 wherein the secondary multimedia information is overlaid at a preselected location of the first dynamic multimedia information.

14. The system according to claim 11 wherein the secondary multimedia information is dynamic.

15. The system according to claim 11 wherein the criteria for displaying the secondary multimedia information within the first dynamic multimedia information includes any combination of the following: a random temporal moment or a moment scheduled in such a way to surprise a viewer of the secondary multimedia information based upon a second predefined criteria.

16. The system according to claim 11 wherein the secondary multimedia information is an advertisement.

17. The system according to claim 11 wherein the secondary multimedia information is overlaid onto a dynamic aspect within the first multimedia information.

18. The system according to claim 11 wherein the secondary multimedia information is overlaid onto the first multimedia information at a preselected location of the first multimedia information.

19. The system according to claim 11 wherein the first multimedia information includes at least one of: video, image, hologram, augmented reality, virtual reality, graphic interchange format image, audio, odor, neural file, or haptic signal.

20. A non-transitory computer-readable medium for displaying multimedia information, the non-transitory computer-readable medium having instructions recorded thereon, that when executed by a processor, cause the processor to perform operations including:
receiving data at an electronic device, the data including a first dynamic multimedia information and a secondary multimedia information;
displaying, by the electronic device, on a display the first dynamic multimedia information; and
displaying, based upon a criteria, the secondary multimedia information within the first dynamic multimedia information.
